(19) United States
(12) Patent Application Publication
(10) Pub. No.: US 2025/0306512 A1
(43) Pub. Date: Oct. 2, 2025

(54) DEVELOPING DEVICE AND IMAGE FORMING APPARATUS

(71) Applicant: FUJIFILM Business Innovation Corp., Tokyo (JP)

(72) Inventors: Yasunori UNAGIDA, Kanagawa (JP); Yu TSUDA, Kanagawa (JP)

(73) Assignee: FUJIFILM Business Innovation Corp., Tokyo (JP)

(21) Appl. No.: 18/772,841

(22) Filed: Jul. 15, 2024

(30) Foreign Application Priority Data
Mar. 27, 2024 (JP) 2024-052152

(51) Int. Cl. G03G 15/00; G03G 15/08

(52) U.S. Cl. CPC G03G 15/50; G03G 15/0891; G03G 15/556

(57) ABSTRACT

A developing device includes a first transport unit that includes a helical rotational body and transports a developer by the rotational body being rotated; a second transport unit that includes a helical rotational body and transports the developer in a direction opposite to a direction of the first transport unit by the rotational body being rotated, the rotational body of the second transport unit having a rotation shaft disposed above or below and in parallel to the rotational body of the first transport unit; a developing unit that develops an image with the developer supplied from the first transport unit; a torque detecting unit that detects a torque required for driving the first transport unit and the second transport unit; a first drive unit that drives the first transport unit and the second transport unit at a rotational speed that is specified based on the torque detected by the torque detecting unit; and a second drive unit that differs from the first drive unit and drives the developing unit.

### CROSS-REFERENCE TO RELATED APPLICATIONS

This application is based on and claims priority under 35 USC 119 from Japanese Patent Application No. 2024-052152 filed Mar. 27, 2024.

### BACKGROUND

### (i) Technical Field

The present disclosure relates to a developing device and an image forming apparatus.

### (ii) Related Art

Japanese Unexamined Patent Application Publication No. 2013-101205 discloses a developing device. To maintain the amount of a developer in a development tank within a predetermined range regardless of the variation in the distribution of the developer in the development tank, the developing device develops an electrostatic latent image formed on a photoreceptor with a two-component developer including a carrier and a toner, supplies the developer including the toner mixed with a small amount of the carrier to the development tank in accordance with the consumption of the toner, and discharges a certain amount or more of the developer accumulated in the development tank. The developing device includes a transport member that causes the developer to circulate in a predetermined direction in the development tank; a driver that rotationally drives the transport member; a torque detector that detects the torque of the transport member or a current value detector that detects the current value of the driver; and a controller that controls the rotational speed of the transport member based on the torque detected by the torque detector or the current value detected by the current value detector.

### SUMMARY

The circulation of the developer changes depending on the environment and time elapsed. When a developing unit, and a first transport unit and a second transport unit are driven by the same driver, the rotational speed of the developing unit is changed together with the rotational speed of the first transport unit and the second transport unit, which leads to a deterioration of image quality.

Aspects of non-limiting embodiments of the present disclosure relate to controlling the rotational speed of a first transport unit and a second transport unit while maintaining the image quality by making the rotational speed of a developing unit constant, as compared with a case where a developing unit, and a first transport unit and a second transport unit are driven by the same drive source.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a developing device including a first transport unit that includes a helical rotational body and transports a developer by the rotational body being rotated; a second transport unit that includes a helical rotational body and transports the developer in a direction opposite to a direction of the first transport unit by the rotational body being rotated, the rotational body of the second transport unit having a rotation shaft disposed above or below and in parallel to the rotational body of the first transport unit; a developing unit that develops an image with the developer supplied from the first transport unit; a torque detecting unit that detects a torque required for driving the first transport unit and the second transport unit; a first drive unit that drives the first transport unit and the second transport unit at a rotational speed that is specified based on the torque detected by the torque detecting unit; and a second drive unit that differs from the first drive unit and drives the developing unit.

### BRIEF DESCRIPTION OF THE DRAWINGS

Exemplary embodiments of the present disclosure will be described in detail based on the following figures, wherein:

FIG. 1 illustrates an example of an image forming apparatus to which an exemplary embodiment is applied;

FIG. 2 illustrates an example of a hardware configuration of a control device;

FIG. 3 is a sectional view of a developing device as viewed in a direction in which the developing device extends;

FIG. 4 is a sectional view of the developing device as viewed from the front;

FIG. 5 illustrates an example of a drive mechanism according to a first exemplary embodiment;

FIG. 6 is a graph presenting an example of the relationship between the torque and the motor current;

FIG. 7 is a graph presenting an example of the relationship between the motor current and the amount of a developer;

FIG. 8 is a graph presenting an example of the relationship between the torque required for the rotation and the rotational speed of a first transport member and a second transport member;

FIGS. 9A to 9C are graphs presenting detected torque waveforms, FIG. 9A presenting an example of a first mode of the torque waveform, FIG. 9B presenting an example of a second mode of the torque waveform, FIG. 9C presenting an example of a third mode of the torque waveform;

FIGS. 10A and 10B are graphs presenting abnormalities in torque waveforms, FIG. 10A presenting one example, FIG. 10B presenting another example;

FIG. 11 illustrates an example of a drive mechanism according to a second exemplary embodiment; and

FIG. 12 is a graph presenting an example of the relationship between the rotational speed ratio and the torque of a first transport member and a second transport member.

### DETAILED DESCRIPTION

Hereinafter, exemplary embodiments of the present disclosure will be described with reference to the accompanying drawings.

### Configuration of Image Forming Apparatus

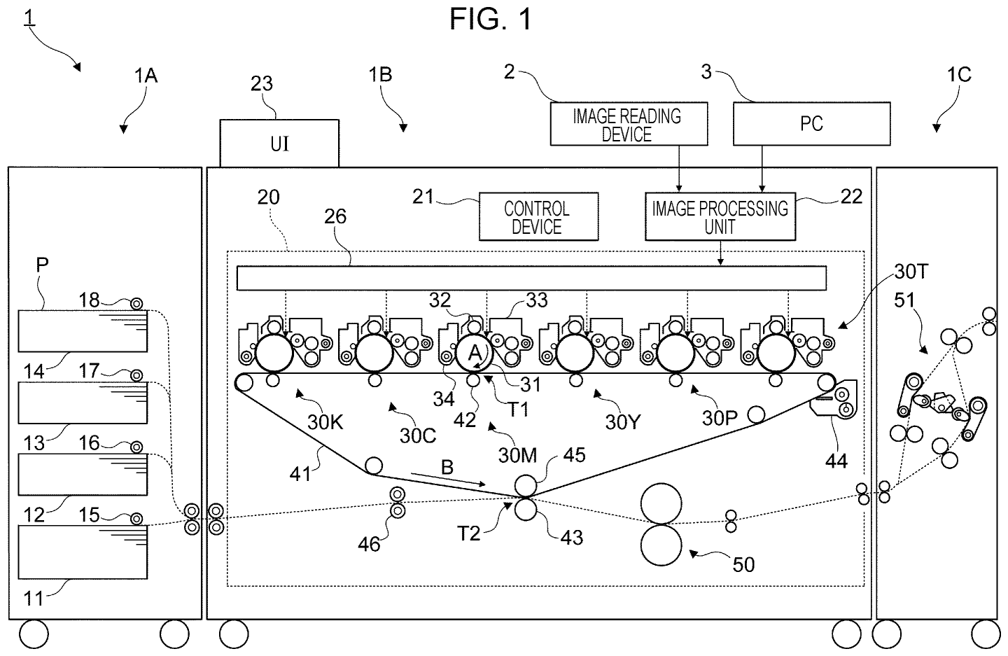

FIG. 1 illustrates an example of an image forming apparatus to which an exemplary embodiment is applied. An image forming apparatus 1 according to the exemplary embodiment includes a paper feed unit 1A, a print unit 1B, and a paper output unit 1C.

The paper feed unit 1A includes a first sheet housing portion 11 to a fourth sheet housing portion 14 that house sheets P as an example of recording media. The paper feed unit 1A is provided with sending rollers 15 to 18 that are provided to correspond to the first sheet housing portion 11 to the fourth sheet housing portion 14, respectively, and each of which sends a sheet P housed in the corresponding sheet housing portion to a transport path connected to the print unit 1B.

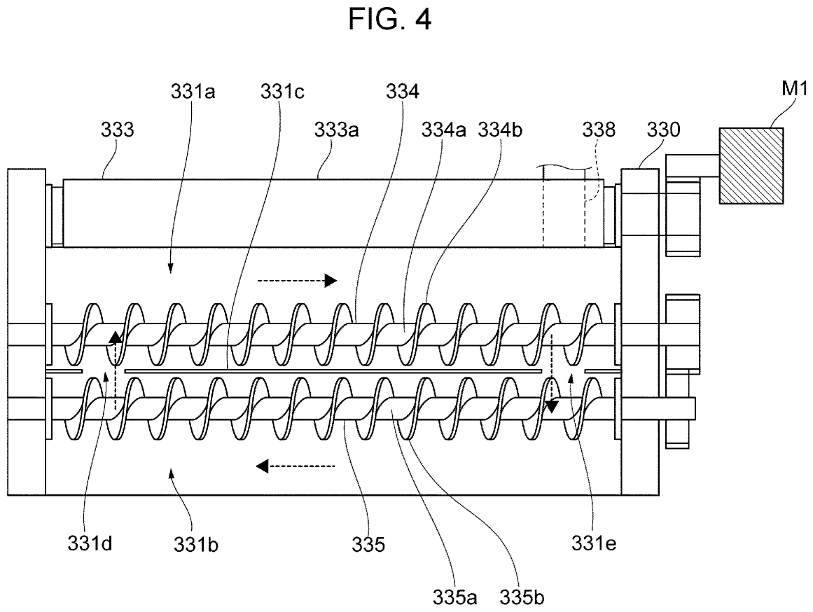

The print unit 1B includes an image forming section 20 that forms an image on a sheet P. The print unit 1B is provided with a control device 21 that controls each component of the image forming apparatus 1. The control device 21 controls an image forming operation performed by the image forming section 20. In the present exemplary embodiment, the control device 21 performs control to change the rotational speed of a first transport member 334 (see FIG. 4) and a second transport member 335 (see FIG. 4) that stir and transport a developer, in relation to an operation of a developing device 33 (described later) in the image forming section 20. The control on the rotational speed of the first transport member 334 and the second transport member 335 will be described later.

The print unit 1B includes an image processing unit 22. The image processing unit 22 performs image processing on image data transmitted from an image reading device 2 or a personal computer (PC) 3. The print unit 1B is provided with a user interface (UI) 23 that includes a touch panel or the like, notifies a user of information, and receives an input of information from the user.

The image forming section 20 as an example of an image forming device is provided with six image forming units 30T, 30P, 30Y, 30M, 30C, and 30K (hereinafter, simply referred to as “image forming unit” in some cases) disposed in parallel at regular intervals. Each image forming unit 30 includes a photoreceptor drum 31 on which an electrostatic latent image is formed while rotating in a direction of arrow A, a charging roller 32 that electrically charges the surface of the photoreceptor drum 31, a developing device 33 that develops the electrostatic latent image formed on the photoreceptor drum 31, and a drum cleaner 34 that removes the toner and the like on the surface of the photoreceptor drum 31.

The image forming section 20 is provided with an exposure device 26 that exposes the photoreceptor drum 31 of each image forming unit 30 to laser light. The exposure of the photoreceptor drum 31 by the exposure device 26 is not limited to the exposure using laser light. For example, a light source such as a light emitting diode (LED) may be provided for each image forming unit 30, and the photoreceptor drum 31 may be exposed to light using light emitted from the light source.

The image forming units 30 are configured similarly except for toners housed in the developing devices 33. The image forming units 30Y, 30M, 30C, and 30K form toner images of yellow (Y), magenta (M), cyan (C), and black (K), respectively. The image forming units 30T and 30P form toner images using a toner corresponding to a corporate color, a foaming toner for Braille, a fluorescent color toner, a toner for improving glossiness, and the like. That is, the image forming units 30T and 30P form toner images using toners of special colors.

The image forming section 20 is provided with an intermediate transfer belt 41 onto which the toner images of the respective colors formed on the photoreceptor drums 31 of the image forming units 30 are transferred. The image forming section 20 is provided with a first transfer roller 42 that transfers each of the toner images of the respective colors of the image forming units 30 onto the intermediate transfer belt 41 at a first transfer portion T1. The image forming section 20 is provided with a second transfer roller 43 that collectively transfers the toner images transferred on the intermediate transfer belt 41 onto a sheet P at a second transfer portion T2. The image forming section 20 is provided with a belt cleaner 44 that removes the toners and the like on the surface of the intermediate transfer belt 41, and a fixing device 50 that fixes the second-transferred image to the sheet P.

### Hardware Configuration of Control Device

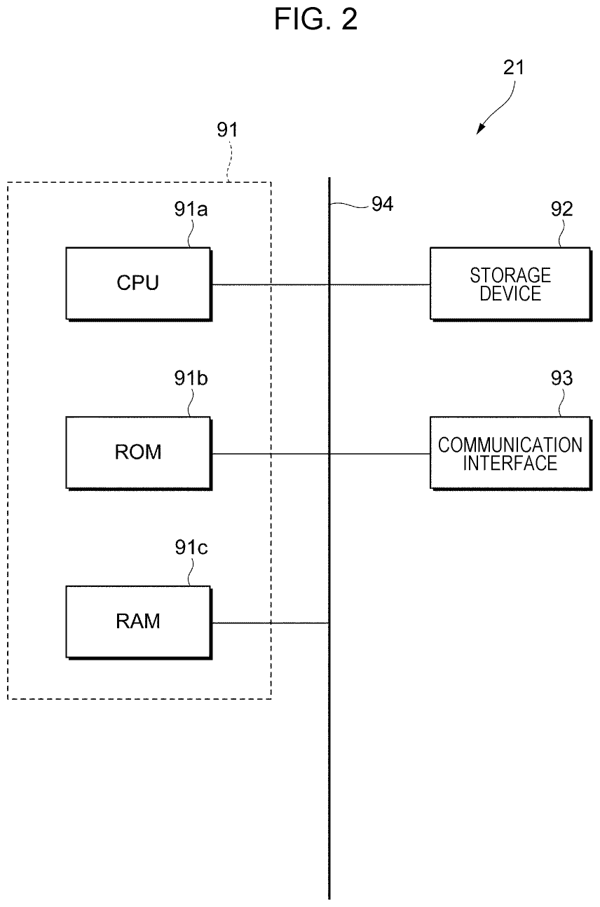

FIG. 2 illustrates an example of a hardware configuration of the control device 21. The control device 21 is provided with an arithmetic processing unit 91, a storage device 92 that stores various kinds of information, and a communication interface 93 for performing communication with an external device. The arithmetic processing unit 91 includes a computer. The arithmetic processing unit 91 includes a central processing unit (CPU) 91a as an example of a processor that executes various kinds of processing (described later). The arithmetic processing unit 91 includes a read only memory (ROM) 91b in which a program is stored and a random access memory (RAM) 91c used as a work area. The storage device 92 is implemented by an existing device such as a hard disk drive or a semiconductor memory. The arithmetic processing unit 91 and the storage device 92 are connected to each other via a bus 94 or a signal line (not illustrated).

The program to be executed by the CPU 91a may be provided to the control device 21, in a state of being stored in a computer-readable recording medium, such as a magnetic recording medium (magnetic tape, magnetic disk, or the like), an optical recording medium (optical disk or the like), a magneto-optical recording medium, or a semiconductor memory. Alternatively, the program to be executed by the CPU 91a may be provided to the control device 21 using a communication device. The program provided to the control device 21 is stored in the storage device 92.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device). In the embodiments above, the term “processor” is broad enough to encompass one processor or plural processors in collaboration which are located physically apart from each other but may work cooperatively. The order of operations of the processor is not limited to one described in the exemplary embodiments, and may be changed.

### Image Forming Operation Performed by Image Forming Apparatus

The following operation is performed by the CPU 91a executing the program stored in the storage device 92.

The image forming section 20 performs an image forming operation based on a control signal from the control device 21. Specifically, in the image forming section 20, the image processing unit 22 performs image processing on image data input from the image reading device 2 or the PC 3, and the image data with the image processing performed is supplied to the exposure device 26. For example, in the image forming unit 30Y for yellow (Y), the charging roller 32 electrically charges the surface of the photoreceptor drum 31, and then the exposure device 26 emits laser light modulated in accordance with the image data obtained from the image processing unit 22, to the photoreceptor drum 31.

Accordingly, an electrostatic latent image is formed on the photoreceptor drum 31. The formed electrostatic latent image is developed by the developing device 33, and a yellow toner image is formed on the photoreceptor drum 31. Similarly, magenta, cyan, and black toner images are formed in the image forming units 30M, 30C, and 30K, and toner images of special colors are formed in the image forming units 30T and 30P.

The toner images of the respective colors formed by the respective image forming units 30 are sequentially electrostatically transferred onto the intermediate transfer belt 41 rotating in a direction of arrow B in FIG. 1 by the first transfer rollers 42, and superimposed toner images are formed on the intermediate transfer belt 41. The superimposed toner images formed on the intermediate transfer belt 41 are transported to the second transfer portion T2 defined by the second transfer roller 43 and a backup roller 45 by the movement of the intermediate transfer belt 41.

In contrast, a sheet P is taken out from, for example, the first sheet housing portion 11 by the sending roller 15, and then transported to the position of a registration roller 46 through the transport path. When the superimposed toner images are transported to the second transfer portion T2, the sheet P is supplied from the registration roller 46 to the second transfer portion T2 in synchronization with the timing. At the second transfer portion T2, the superimposed toner images are collectively electrostatically transferred onto the sheet P by the action of a transfer electric field formed between the second transfer roller 43 and the backup roller 45.

Then, the sheet P with the superimposed toner images electrostatically transferred is transported to the fixing device 50. In the fixing device 50, the sheet P on which an unfixed toner image (superimposed toner images) is formed is pressed and heated, and fixing processing for the toner image to the sheet P is performed. The sheet P with the fixing processing performed is transported to a sheet stacking portion (not illustrated) via a curl correcting portion 51 provided in the paper output unit 1C.

In the present exemplary embodiment, the control device 21 estimates the amount of the developer. When the amount of the developer is decreased by the image forming operation and becomes a predetermined threshold value or less, the user is notified of the amount of the developer via the UI 23 or the like. The threshold value may be determined to any value by the user. The amount of the developer is estimated based on a torque (described later). The control device 21 is an example of a developer amount estimation unit and an example of a notification unit.

### Configuration of Developing Device

Next, a configuration of the developing device 33 will be described.

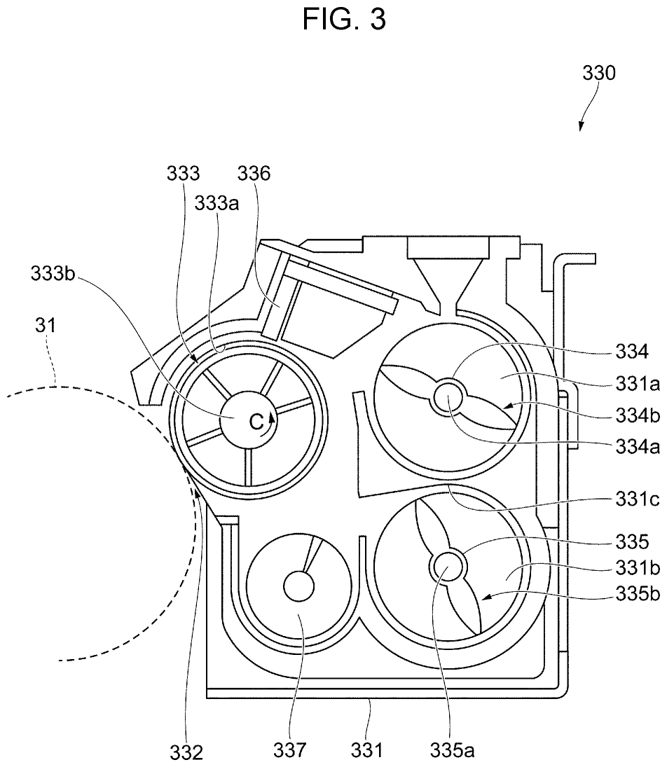

FIG. 3 is a sectional view of the developing device 33 as viewed in a direction in which the developing device 33 extends. FIG. 4 is a sectional view of the developing device 33 as viewed from the front.

As illustrated in FIG. 3, the developing device 33 includes a housing 330. The housing 330 has a housing chamber 331 that houses the developer, and has a development opening 332 in one side surface. The developing device 33 includes a developing roller 333, a first transport member 334, a second transport member 335, a regulating member 336, and a feed-in transport member 337 inside the housing 330. The developing roller 333 rotates while holding the developer in the housing chamber 331 inside the development opening 332, thereby transporting the developer to a development region facing the photoreceptor drum 31. The developing roller 333 is an example of a developing unit. The first transport member 334 and the second transport member 335 transport the developer in the housing chamber 331 while stirring the developer. The regulating member 336 regulates the amount of the developer held by the developing roller 333. As the developer, for example, a two-component developer containing a non-magnetic toner and a magnetic carrier is used.

### Inside of Housing

The housing chamber 331 of the housing 330 has a horizontally long container shape extending in the axial direction of the photoreceptor drum 31 (in FIG. 3, in a direction from the near side to the depth side of paper). The housing chamber 331 is provided with a first transport path 331a and a second transport path 331b extending in the axial direction of the photoreceptor drum 31. The first transport path 331a and the second transport path 331b are divided to be disposed one above the other by a partition wall 331c that provides partition between the first transport path 331a and the second transport path 331b.

As illustrated in FIG. 4, the first transport path 331a and the second transport path 331b are connected to each other via connection paths 331d and 331e provided at end portions in the longitudinal direction or at positions slightly inside the end portions. Accordingly, the developer is transported from one transport path, for example, the first transport path 331a, to the other transport path, that is, the second transport path 331b, through the connection paths 331d and 331e. Of the two transport paths 331a and 331b, the upper first transport path 331a close to the developing roller 333 functions as a stirring-and-supplying transport path that serves to stir the developer and supply the developer to the developing roller 333. The lower second transport path 331b distant from the developing roller 333 functions as a stirring transport path that mainly serves to stir the developer. The first transport member 334 serves to stir the developer and supply the developer to the developing roller 333 in the first transport path 331a. The second transport member 335 serves to stir the developer in the second transport path 331b. The first transport member 334 and the first transport path 331a are an example of a first transport unit. The second transport member 335 and the second transport path 331b are an example of a second transport unit.

### Development Opening

As illustrated in FIG. 3, the development opening 332 is provided at substantially the same height as the height of the first transport path 331a in the housing 330. The development opening 332 is provided as an opening portion having a horizontally long rectangular shape extending in the axial direction of the photoreceptor drum 31. The development opening 332 is connected to the first transport path 331a and the second transport path 331b via a space extending in the axial direction of the photoreceptor drum 31. The developing roller 333 is disposed inside the housing 330 so as to rotate in a state in which a portion of the peripheral surface of the developing roller 333 is exposed from the development opening 332.

### Developing Roller

The developing roller 333 includes a magnet roller 333b having multiple magnetic poles disposed at intervals on the outer peripheral surface of the magnet roller 333b, and a cylindrical sleeve 333a that covers the magnet roller 333b. The sleeve 333a is formed of, for example, a nonmagnetic material such as stainless steel or aluminum.

As illustrated in FIG. 4, the developing roller 333 is rotated by a necessary rotational power transmitted from a drive device M1 to a shaft portion at one end portion of the sleeve 333a. The drive device M1 is an example of a second drive unit. A development voltage is supplied to the sleeve 333a of the developing roller 333 from a power supply device (not illustrated), and a development electric field is formed between the developing roller 333 and the photoreceptor drum 31 during development.

### Transport Member

As illustrated in FIG. 4, the first transport member 334 and the second transport member 335 are formed in forms in which transport blades 334b and 335b respectively continuous with the peripheral surfaces of rotation shafts 334a and 335a are helically wound at a constant interval in the axial direction. Of these transport members, the first transport member 334 is provided at side surface portions of the housing 330 in the first transport path 331a via bearings. The second transport member 335 is provided at the side surface portions of the housing 330 in the second transport path 331b via bearings.

The first transport member 334 and the second transport member 335 are rotated by a necessary rotational power transmitted to shaft portions at one end portions of the first transport member 334 and the second transport member 335 from a drive device M2 that differs from the drive device M1 (described later). The drive device M2 is an example of a first drive unit.

The feed-in transport member 337 illustrated in FIG. 3 is a columnar member disposed in parallel to the developing roller 333, the first transport member 334, the second transport member 335, and the like inside the housing 330. The feed-in transport member 337 is disposed below the developing roller 333 in the example illustrated in FIG. 3, and feeds the developer separated from the developing roller 333 into the second transport path 331b by rotation about the shaft.

### Regulating Member

The regulating member 336 is a rectangular plate member extending in the axial direction of the developing roller 333. The regulating member 336 is formed of, for example, a nonmagnetic material such as stainless steel. The regulating member 336 is attached to an upper surface portion of the housing 330 via a support member in a state in which one end portion of the regulating member 336 in the longitudinal direction faces the outer peripheral surface of the sleeve 333a of the developing roller 333 with a gap having a constant distance therebetween and in a state in which the regulating member 336 extends in the axial direction of the sleeve 333a and faces the sleeve 333a.

As illustrated in FIG. 4, the developing device 33 is configured to be replenished with the developer from a replenisher (not illustrated) via a connection portion 338. Broken-line arrows in the drawing indicate movement directions of the developer. In the developing device 33, the replenished developer is transported while being mixed with the existing developer.

### Operation of Developing Device

Next, an operation of the developing device 33 will be described. The following operation is performed by the CPU 91a executing the program stored in the storage device 92. When a predetermined drive timing such as an image forming operation comes, the following operation is performed. In the developing device 33, the rotational power is transmitted from the drive device M1, and the sleeve 333a of the developing roller 333 starts to rotate in a direction indicated by arrow C in FIG. 3. The rotational power is transmitted from a drive device M2 (described later), the first transport member 334 starts to rotate in the first transport path 331a, and the second transport member 335 starts to rotate in the second transport path 331b.

The development voltage is supplied to the sleeve 333a of the developing roller 333 from the power supply device (not illustrated). Accordingly, the developer housed in the first transport path 331a of the developing device 33 is transported to the developing roller 333 while being stirred by the transport force of the first transport member 334. At this time, in the first transport path 331a, part of the developer being transported is attracted to the developing roller 333 and supplied. The developer attracted to and held by the developing roller 333 is regulated in the amount of passage when passing through the regulating member 336. The developer that has passed through the regulating member 336 is transported to the development region facing the photoreceptor drum 31 and is applied to a developing process.

Part of the developer that has been transported by the developing roller 333 and passed through the development region is separated from the developing roller 333 and returned to the second transport path 331b. The developer that has not been attracted to the developing roller 333 in the first transport path 331a and has been transported to the connection path 331e is moved so as to fall to the second transport path 331b through the connection path 331e and transported. In contrast, the developer housed in the second transport path 331b, including the developer transported from the first transport path 331a through the connection path 331e, is transported while being stirred by the transport force of the second transport member 335.

The developer transported in the second transport path 331b to the connection path 331d is transported to the first transport path 331a through the connection path 331d by receiving the transport force of the second transport member 335. The developer transported to the first transport path 331a is transported similarly as described above. The developer is circulated and transported in the first transport path 331a and the second transport path 331b as indicated by the broken-line arrows in FIG. 4, except for part of the developer, such as the developer attracted to the developing roller 333.

In the developing device 33, when the developer in the housing chamber 331 is consumed and decreased by development, the developer is replenished from the replenisher (not illustrated) via the connection portion 338 based on information for detecting a decrease in toner. The information for detecting a decrease in toner will be described later.

### Drive Mechanism

Next, an exemplary embodiment of a drive mechanism for rotationally driving the first transport member 334 and the second transport member 335 will be described. The drive mechanism is controlled by the CPU 91a executing the program stored in the storage device 92.

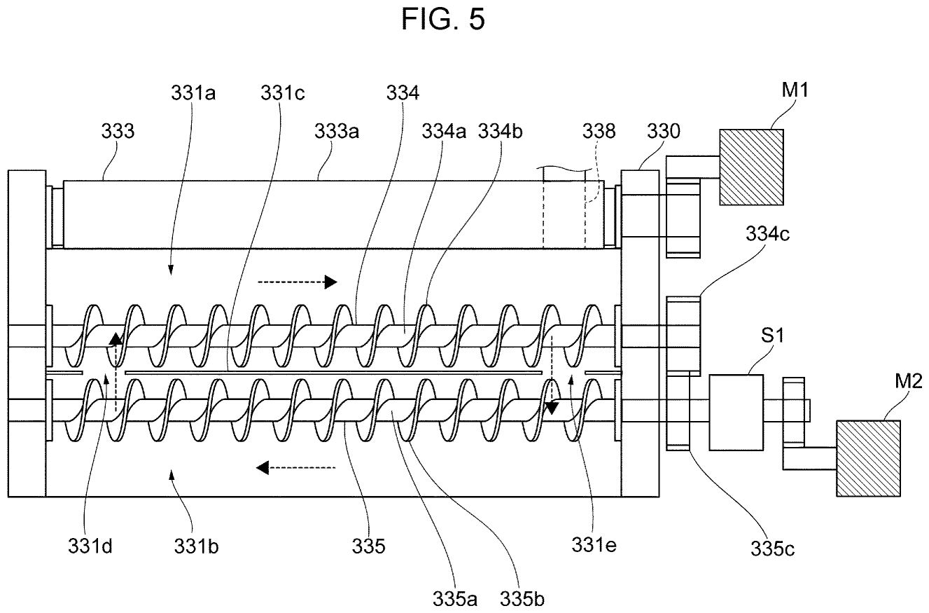

FIG. 5 illustrates an example of a drive mechanism according to a first exemplary embodiment. The drive mechanism according to the first exemplary embodiment rotationally drives the first transport member 334 and the second transport member 335 by one drive device M2. In the example illustrated in FIG. 5, the drive device M2 is connected to the second transport member 335. The drive device M2 may be connected to any one of the first transport member 334 and the second transport member 335, and may be connected to the first transport member 334.

In the configuration illustrated in FIG. 5, the drive device M2 is provided at the shaft portion at the one end portion of the second transport member 335 in the developing device 33. The rotational power supplied from the drive device M2 is branched by drive transmission mechanisms 334c and 335c and transmitted to the respective rotation shafts 334a and 335a. Accordingly, the first transport member 334 and the second transport member 335 are rotationally driven.

### Detection of Torque

In the developing device 33 according to the first exemplary embodiment, as illustrated in FIG. 5, a torque sensor S1 is provided at the drive device M2. The torque sensor S1 detects the torque required for the rotation of the first transport member 334 and the second transport member 335 about the rotation shafts, which are driven by the drive device M2. In the first exemplary embodiment, the torque sensor S1 detects the torque required for the second transport member 335 to rotate about the rotation shaft 335a. The torque sensor S1 is an example of a torque detecting unit.

The relationship between the torque of the drive device M2 and the rotational speed of the first transport member 334 and the second transport member 335 will be described. The circulation of the developer changes depending on the environment and time elapsed. When the force for transporting the developer from the second transport path 331b to the first transport path 331a is insufficient, the developer may be unevenly distributed in the second transport path 331b. The uneven distribution of the developer in the first transport path 331a and the second transport path 331b affects the rotational speed of the first transport member 334 and the second transport member 335.

The amount of the developer in the first transport path 331a and the second transport path 331b correlates with the torque required for the rotation of the first transport member 334 and the second transport member 335. Thus, in the first exemplary embodiment, the torque sensor S1 is used to detect a change in the torque applied to the second transport member 335, and detect the uneven distribution of the developer. Then, the rotational speed of the first transport member 334 and the second transport member 335 is adjusted in accordance with the detected change in the torque, and the uneven distribution of the developer may be addressed. Alternatively, instead of using the torque sensor S1, a motor current may be used to detect the torque required for the rotation of the first transport member 334 and the second transport member 335.

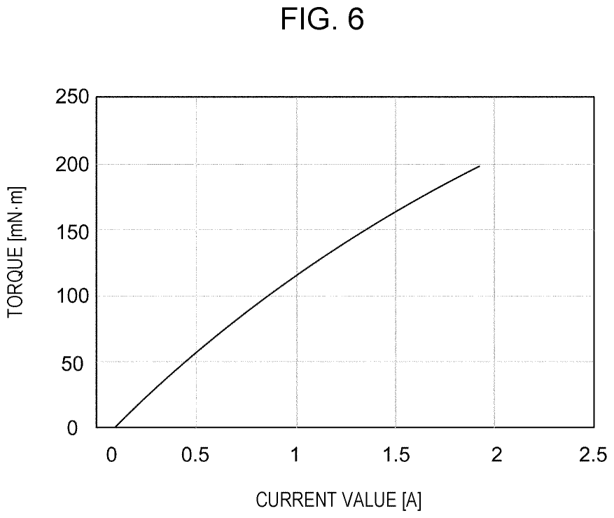

FIG. 6 is a graph presenting an example of the relationship between the torque and the motor current. In the graph presented in FIG. 6, the vertical axis represents the torque (mN·m), and the horizontal axis represents the motor current value (A). FIG. 6 presents the relationship between the torque and the motor current, in which the torque increases as the motor current increases, and the torque decreases as the motor current decreases. In other words, it may be said that the torque correlates with the motor current. Thus, a current sensor may be used as another example of the torque detecting unit. In this case, the motor current from the drive device M2 is measured, and the torque may be obtained based on the relationship between the current value and the torque as presented in FIG. 6. It is possible to find correlations between the motor current and the amount of the developer in the first transport path 331a and the second transport path 331b.

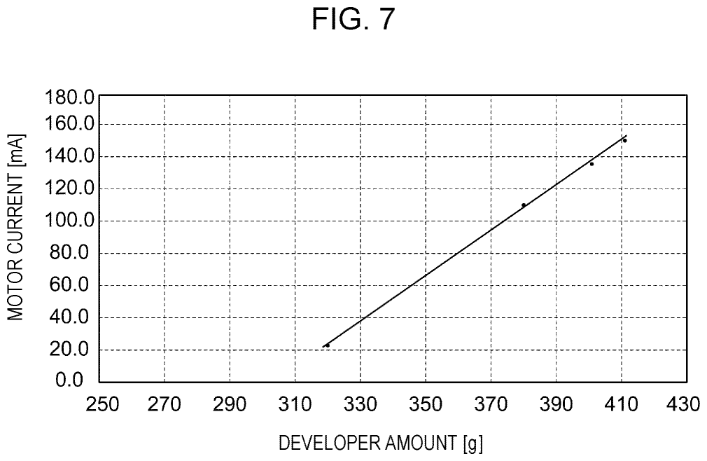

FIG. 7 is a graph presenting an example of the relationship between the motor current and the amount of the developer. In the graph presented in FIG. 7, the vertical axis represents the motor current (mA), and the horizontal axis represents the amount of the developer. The example presented in FIG. 7 presents the relationship in which the motor current increases as the amount of the developer increases, and the motor current decreases as the amount of the developer decreases. Referring to FIGS. 6 and 7, it is found that the amount of the developer in the first transport path 331a and the second transport path 331b correlates with the torque required for the rotation of the first transport member 334 and the second transport member 335. The CPU 91a may estimate the amount of the developer by using the correlation between the torque and the amount of the developer. When the amount of the developer is less than a predetermined amount, the user may be notified of the amount of the developer via the UI 23 or the like.

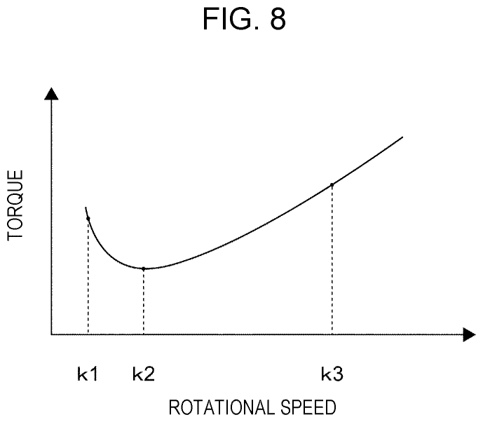

FIG. 8 is a graph presenting an example of the relationship between the torque required for the rotation and the rotational speed of the first transport member 334 and the second transport member 335. In the graph presented in FIG. 8, the vertical axis represents the torque, and the horizontal axis represents the rotational speed of the first transport member 334 and the second transport member 335. In FIG. 8, three different rotational speeds k1, k2, and k3 are indicated in the graph.

When the developer is unevenly distributed to the transport path of one of the first transport member 334 and the second transport member 335, the torque increases based on the amount of the developer in the transport path where the uneven distribution occurs. In the example presented in FIG. 8, at the rotational speed k1, the torque is presented in a case where the developer is unevenly distributed to the second transport path 331b because the force for transporting the developer from the second transport path 331b to the first transport path 331a is insufficient.

In this case, when the rotational speed of the transport member is increased, the circulation of the developer is improved, and the torque decreases. In the example presented in FIG. 8, as the rotational speed increases from the rotational speed k1 to the rotational speed k2, the circulation of the developer in the second transport path 331b is improved, and the torque decreases. When the rotational speed of the transport member is further increased from this state, the movement distance of the developer per unit time increases, and the torque increases accordingly. In the graph presented in FIG. 8, the torque increases from the rotational speed k2 to the rotational speed k3.

### Drive Control Based on Torque

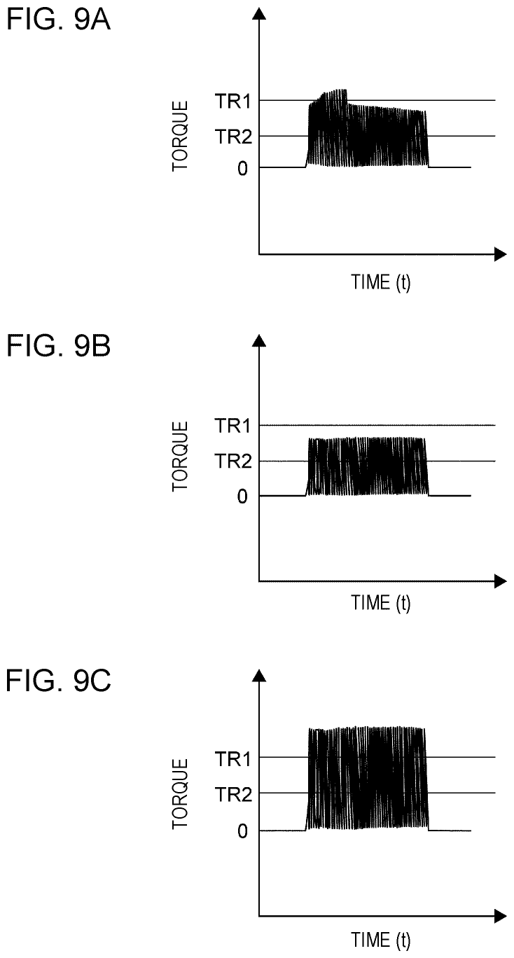

FIGS. 9A to 9C are graphs presenting detected torque waveforms, FIG. 9A presenting an example of a first mode of the torque waveform, FIG. 9B presenting an example of a second mode of the torque waveform, FIG. 9C presenting an example of a third mode of the torque waveform. In each of the graphs in FIGS. 9A to 9C, the vertical axis represents the magnitude of the torque, and the horizontal axis represents the time (t). In each of the graphs presented in FIGS. 9A to 9C, an upper limit value TR1 and a lower limit value TR2 of the torque are indicated. In FIGS. 9A to 9C, it is assumed that the amount of the developer circulating in the first transport path 331a and the second transport path 331b is the same. It is assumed that the rotational speed of the first transport member 334 and the second transport member 335 increases in the order of FIG. 9A, FIG. 9B, and FIG. 9C. Drive control is performed so that the torque waveforms presented in FIGS. 9A to 9C each are in a stable state in a range between the upper limit value TR1 and the lower limit value TR2.

FIG. 9A presents a torque waveform in a case where the developer is unevenly distributed. As described above, when the force for transporting the developer from the second transport path 331b to the first transport path 331a is insufficient, the developer is unevenly distributed in the second transport path 331b. That is, the amount of the developer in the second transport path 331b increases. In this case, the torque increases in a short period of time, and hence, as presented in FIG. 9A, the torque waveform becomes an unstable waveform. In the example presented in FIG. 9A, the torque exceeds the upper limit value TR1 of the torque in the period in which the torque increases. Thus, when such an unstable torque waveform is detected, the rotational speed of the first transport member 334 and the second transport member 335 is increased to address the uneven distribution of the developer. Accordingly, the circulation of the developer is improved and the uneven distribution of the developer is addressed.

The graph presented in FIG. 9B presents a torque waveform in a case where the rotational speed of the first transport member 334 and the second transport member 335 is increased as compared with the case presented in FIG. 9A. The magnitude of the torque presented in FIG. 9B is substantially constant, and the torque waveform maintains a stable state. Thus, the developer is not unevenly distributed in the first transport path 331a and the second transport path 331b. By increasing the rotational speed of the first transport member 334 and the second transport member 335 from the state presented in FIG. 9A, the uneven distribution of the developer in the first transport path 331a and the second transport path 331b is addressed. Accordingly, the torque waveform is stabilized as presented in FIG. 9B. In the example presented in FIG. 9B, the magnitude of the torque is within the range between the upper limit value TR1 and the lower limit value TR2.

As described above, when the rotational speed of the first transport member 334 and the second transport member 335 is increased, the torque increases. FIG. 9C presents a torque waveform in a case where the rotational speed of the first transport member 334 and the second transport member 335 is further increased as compared with the case presented in FIG. 9B. Also in FIG. 9C, the magnitude of the torque is substantially constant, and the torque waveform transitions in a stable state. Thus, the developer is not unevenly distributed in the first transport path 331a and the second transport path 331b.

In the torque waveform presented in FIG. 9C, a larger torque is detected as compared with the waveform presented in FIG. 9B. Specifically, in the example presented in FIG. 9C, the magnitude of the torque continues to exceed the upper limit value TR1. When the torque is large, the load on the first transport member 334 and the second transport member 335 is large. Thus, the rotational speed of the first transport member 334 and the second transport member 335 is decreased within a range in which the torque waveform is stable, and the load applied to the first transport member 334 and the second transport member 335 is decreased.

In the examples presented in FIGS. 9B and 9C, the magnitude of the torque is substantially constant and the torque waveform is stable in any case. Thus, in any case, the developer is not unevenly distributed in the first transport path 331a and the second transport path 331b. However, in the example of FIG. 9B, the magnitude of the torque is between the upper limit value TR1 and the lower limit value TR2, whereas in the example of FIG. 9C, the magnitude of the torque continues to exceed the upper limit value TR1. Thus, the rotational speed of the first transport member 334 and the second transport member 335 in the case of FIG. 9B is selected.

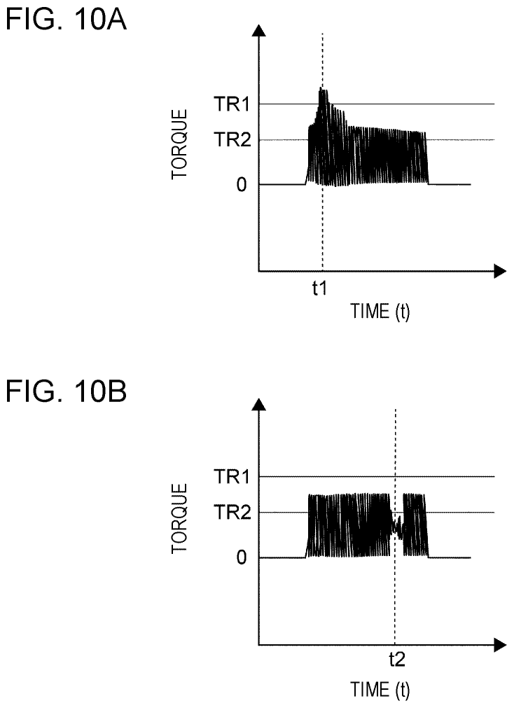

FIGS. 10A and 10B are graphs presenting abnormalities in torque waveforms, FIG. 10A presenting one example, FIG. 10B presenting another example. In each of the graphs presented in FIGS. 10A and 10B, the vertical axis represents the magnitude of the torque and the horizontal axis represents the time (t) similarly to FIGS. 9A to 9C. In each of the graphs presented in FIGS. 10A and 10B, an upper limit value TR1 and a lower limit value TR2 of the torque are indicated.

In the example presented in FIG. 10A, the torque rapidly increases at a time point t1 and exceeds the upper limit value TR1, which exhibits an abnormality in the rise. In this way, when the torque exhibits a rapid fluctuation and exceeds the upper limit value TR1, it is estimated that the developer is unevenly distributed. In contrast, in the example presented in FIG. 10B, the torque rapidly decreases at a time point t2 and falls below the lower limit value TR2, and thus an abnormality is detected. In this way, when the torque exhibits a rapid fluctuation and falls below the lower limit value TR2, it is estimated that the developer is unevenly distributed.

As described above, when the magnitude of the torque rapidly fluctuates at a certain time point and exceeds the upper limit value TR1 or falls below the lower limit value TR2, it is expected that the developer is in an abnormal state such as uneven distribution or retention. Thus, the rotational speed of the first transport member 334 and the second transport member 335 is increased to address the uneven distribution of the developer, thereby preventing the drive device M2 from performing an abnormal operation such as a loss of synchronization.

### Another Exemplary Embodiment of Drive Mechanism

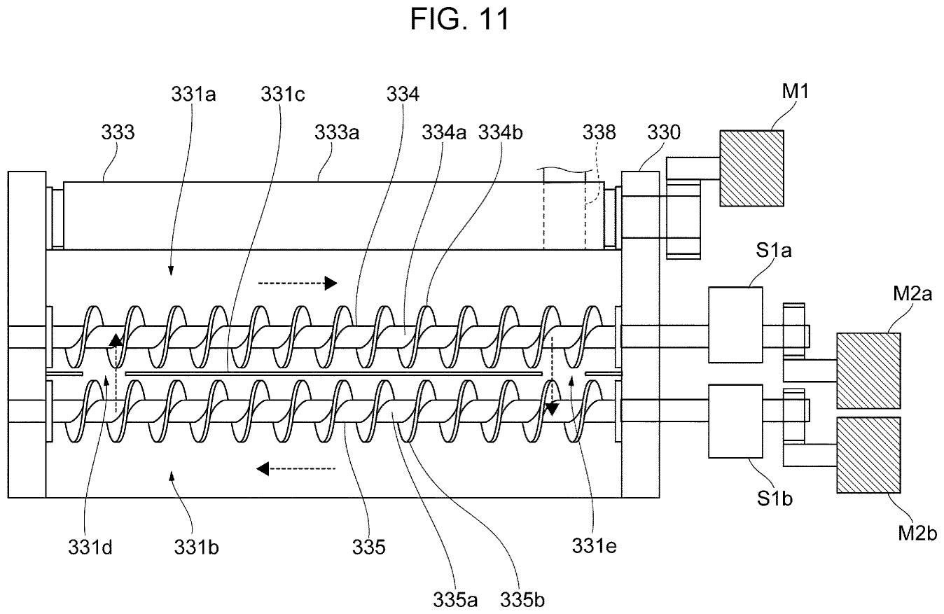

FIG. 11 illustrates an example of a drive mechanism according to a second exemplary embodiment. In the first exemplary embodiment illustrated in FIG. 5, the first transport member 334 and the second transport member 335 are rotationally driven by one drive device M2. In contrast, in the second exemplary embodiment, as illustrated in FIG. 11, a drive device M2a and a drive device M2b are provided at shaft portions at one end portions of the first transport member 334 and the second transport member 335. In the second exemplary embodiment, the first transport member 334 is rotated by a rotational power from the drive device M2a, and the second transport member 335 is rotated by a rotational power from the drive device M2b. Accordingly, in the second exemplary embodiment, the developing roller 333, the first transport member 334, and the second transport member 335 are driven independently of one another.

### Detection of Torque

In the developing device 33 according to the second exemplary embodiment, as illustrated in FIG. 11, a torque sensor Sla is provided at the drive device M2a. A torque sensor S1b is provided at the drive device M2b. In the second exemplary embodiment, as illustrated in FIG. 11, the torque sensor Sla is provided between the first transport member 334 and the drive device M2a, and detects the force that is applied when the first transport member 334 rotates about the rotation shaft 334a. The torque sensor S1b is provided between the second transport member 335 and the drive device M2b, and detects the force that is applied when the second transport member 335 rotates about the rotation shaft 335a. The other configurations are similar to those of the first exemplary embodiment. The torque sensor Sla and the torque sensor S1b are examples of a torque detecting unit.

When the balance of transport capabilities of the first transport member 334 and the second transport member 335 that are disposed one above the other is lost, the developer in the housing chamber 331 may be unevenly distributed to one of the first transport path 331a and the second transport path 331b. When the developer is unevenly distributed to one of the transport paths, the torque of the one transport path increases, and the torque of the other transport path decreases. In contrast, when the torque for rotating the first transport member 334 and the torque for rotating the second transport member 335 are compared and the magnitudes of the torques are substantially equal, it may be said that the developer is not unevenly distributed.

Thus, in the second exemplary embodiment, the uneven distribution of the developer is detected using the difference in the magnitude between the respective torques detected by the torque sensor Sla and the torque sensor S1b. Then, based on the detection result of the uneven distribution of the developer, the control on the rotational speed of each of the first transport member 334 and the second transport member 335 is individually performed. This control is executed by the CPU 91a executing the program stored in the storage device 92.

### Drive Control Based on Torque

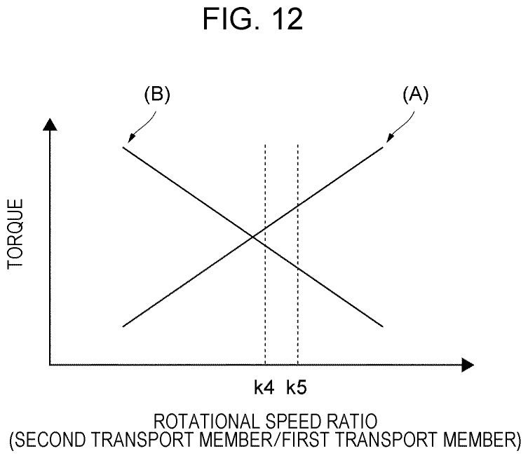

FIG. 12 is a graph presenting an example of the relationship between the rotational speed ratio and the torque of the first transport member 334 and the second transport member 335. In the graph presented in FIG. 12, the vertical axis represents the torque, and the horizontal axis represents the rotational speed ratio. The rotational speed ratio is calculated by (the rotational speed of the second transport member 335)/(the rotational speed of the first transport member 334).

In the graph presented in FIG. 12, a straight line (A) inclined upward to the right indicates the torque detected from the second transport member 335. A straight line (B) inclined downward to the right indicates the torque detected from the first transport member 334.

As described above, the rotational speeds of the first transport member 334 and the second transport member 335 correlate with the torques. That is, as the rotational speed of the first transport member 334 is increased, the torque required for rotating the first transport member 334 increases. As the rotational speed of the second transport member 335 is increased, the torque required for rotating the second transport member 335 increases. Thus, according to the above-described expression in which the rotational speed of the second transport member 335 is the numerator, the line representing the torque of the second transport member 335 is inclined upward to the right in the graph presented in FIG. 12. According to the above-described expression in which the rotational speed of the first transport member 334 is the denominator, the line representing the torque of the first transport member 334 is inclined upward to the left in the graph presented in FIG. 12.

To suppress the uneven distribution of the developer in the first transport path 331a and the second transport path 331b, the rotational speeds of the first transport member 334 and the second transport member 335 need to be substantially the same. However, in the present exemplary embodiment, the first transport path 331a and the second transport path 331b are disposed one above the other, and the developer is more likely to stay in the second transport path 331b due to the influence of the gravity or the like. Thus, the rotational speeds are adjusted so that the torque of the second transport member 335 disposed in the second transport path 331b is larger than the torque of the first transport member 334 to some extent. As an example, the rotational speeds of the first transport member 334 and the second transport member 335 may be adjusted so as to fall within a range between rotational speed ratios k4 and k5 indicated in FIG. 12. When the rotational speeds are adjusted so as to fall within the range between the rotational speed ratios k4 and k5, the amount of the developer in the second transport path 331b may be maintained in a state of being larger than the amount of the developer in the first transport path 331a. Thus, when the developer is replenished through the connection portion 338 (see FIG. 4), the developer is mixed with the existing developer in the second transport path 331b in which the amount of the developer is larger than that in the first transport path 331a. Consequently, it is possible to suppress a rapid increase in the toner concentration in the first transport path 331a and the second transport path 331b.

### Application to Correction of ATC Sensor

As described above, the amount and state of the developer may be determined using the torque required for the rotation of the first transport member 334 and the second transport member 335. It is conceivable to correct an auto toner concentration (ATC) sensor by using this method.

The ATC sensor is a sensor that detects a change in the concentration of the toner in the developer in the developing device 33. The ATC sensor detects the amount of the carrier contained in a unit volume of the developer. In this case, when the amount of the carrier contained in the unit volume of the developer increases, it is found that the amount of the toner contained in the unit volume of the developer relatively decreases (that is, the concentration of the toner decreases). Thus, when such a change is detected by the ATC sensor, the developing device 33 is replenished with the toner.

The developing device 33 of the present exemplary embodiment is a vertical developing unit that causes the developer to vertically circulate as illustrated in FIG. 3. In such a developing device 33, when the capability to bring the developer upward from below is insufficient, the developer is unevenly distributed to the lower second transport path 331b, and the developer is insufficient in the upper first transport path 331a.

In general, in the vertical developing unit such as the developing device 33, the ATC sensor is disposed in the upper first transport path 331a close to the developing roller 333. When the amount of the developer in the first transport path 331a decreases due to the uneven distribution of the developer, the amount of the carrier per unit volume decreases. Hence the ATC sensor may erroneously detect that the toner concentration (TC) of the developer increases.

In contrast, when the state of the developer is determined using the torque required for the rotation of the first transport member 334 and the second transport member 335 by the drive mechanism according to the first and second exemplary embodiments described with reference to FIGS. 5 to 12, the amount of the developer may be accurately grasped. Thus, it is conceivable to specify the amount of the developer based on the torque required for the rotation of the first transport member 334 and the second transport member 335, and to correct the detection result of the ATC sensor based on the specified amount of the developer.

In this way, even when the amount of the developer is not uniform between the first transport path 331a and the second transport path 331b, the erroneous detection of the toner concentration by the ATC sensor may be corrected. By addressing the uneven distribution of the developer by the control on the rotational speed of the first transport member 334 and the second transport member 335, it is possible to expect that the occurrence of erroneous detection by the ATC sensor is suppressed.

Specifically, for example, as described above, a case is considered where the output of the ATC sensor increases due to the uneven distribution of the developer and the toner concentration (TC) is erroneously detected as being increased. At this time, when a decrease in the amount of the developer is detected by the torque detection, correction is performed to decrease the output value of the ATC sensor. In contrast, when the uneven distribution or an increase of the amount of the developer is detected by the torque detection, correction is performed to increase the output value of the ATC sensor. By these corrections, the detection accuracy of the toner concentration (TC) may be improved.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

A developing device comprising: a first transport unit that includes a helical rotational body and transports a developer by the rotational body being rotated; a second transport unit that includes a helical rotational body and transports the developer in a direction opposite to a direction of the first transport unit by the rotational body being rotated, the rotational body of the second transport unit having a rotation shaft disposed above or below and in parallel to the rotational body of the first transport unit; a developing unit that develops an image with the developer supplied from the first transport unit; a torque detecting unit that detects a torque required for driving the first transport unit and the second transport unit; a first drive unit that drives the first transport unit and the second transport unit at a rotational speed that is specified based on the torque detected by the torque detecting unit; and a second drive unit that differs from the first drive unit and drives the developing unit.

(((2)))

The developing device according to (((1))), wherein the first drive unit increases the rotational speed of the first transport unit and the second transport unit when the torque detecting unit detects an increase in the torque.

(((3)))

The developing device according to (((1))) or (((2))), wherein the torque detecting unit is a torque sensor provided at one of the first transport unit and the second transport unit.

(((4)))

The developing device according to any one of (((1))) to (((3))), wherein the first drive unit is one motor connected to the one of the first transport unit and the second transport unit provided with the torque sensor.

(((5)))

The developing device according to (((1))) or (((2))), wherein the torque detecting unit is a torque sensor individually provided at each of the first transport unit and the second transport unit.

(((6)))

The developing device according to (((5))), wherein the first drive unit includes a plurality of respective motors connected to the first transport unit and the second transport unit.

(((7)))

The developing device according to (((6))), wherein the first drive unit drives the first transport unit and the second transport unit that are disposed one above the other so that a torque required for driving the second transport unit disposed in a lower portion is larger than a torque required for driving the first transport unit disposed in an upper portion.

(((8)))

The developing device according to any one of (((1))) to (((7))), further comprising: a developer amount estimation unit that estimates an amount of the developer in the first transport unit and the second transport unit based on the torque detected by the torque detecting unit; and a notification unit that notifies a user when the amount of the developer estimated by the developer amount estimation unit has become a predetermined threshold value or less.

(((9)))

An image forming apparatus comprising the developing device according to any one of (((1))) to (((8))).

What is claimed is:

1. A developing device comprising:
a first transport unit that includes a helical rotational body and transports a developer by the rotational body being rotated;
a second transport unit that includes a helical rotational body and transports the developer in a direction opposite to a direction of the first transport unit by the rotational body being rotated, the rotational body of the second transport unit having a rotation shaft disposed above or below and in parallel to the rotational body of the first transport unit;
a developing unit that develops an image with the developer supplied from the first transport unit;
a torque detecting unit that detects a torque required for driving the first transport unit and the second transport unit;
a first drive unit that drives the first transport unit and the second transport unit at a rotational speed that is specified based on the torque detected by the torque detecting unit; and
a second drive unit that differs from the first drive unit and drives the developing unit.

2. The developing device according to claim 1, wherein the first drive unit increases the rotational speed of the first transport unit and the second transport unit when the torque detecting unit detects an increase in the torque.

3. The developing device according to claim 1, wherein the torque detecting unit is a torque sensor provided at one of the first transport unit and the second transport unit.

4. The developing device according to claim 3, wherein the first drive unit is one motor connected to the one of the first transport unit and the second transport unit provided with the torque sensor.

5. The developing device according to claim 1, wherein the torque detecting unit is a torque sensor individually provided at each of the first transport unit and the second transport unit.

6. The developing device according to claim 5, wherein the first drive unit includes a plurality of respective motors connected to the first transport unit and the second transport unit.

7. The developing device according to claim 6, wherein the first drive unit drives the first transport unit and the second transport unit that are disposed one above the other so that a torque required for driving the second transport unit disposed in a lower portion is larger than a torque required for driving the first transport unit disposed in an upper portion.

8. The developing device according to claim 1, further comprising:
a developer amount estimation unit that estimates an amount of the developer in the first transport unit and the second transport unit based on the torque detected by the torque detecting unit; and
a notification unit that notifies a user when the amount of the developer estimated by the developer amount estimation unit has become a predetermined threshold value or less.

9. An image forming apparatus comprising the developing device according to claim 1.

10. An image forming apparatus comprising the developing device according to claim 2.

11. An image forming apparatus comprising the developing device according to claim 3.

12. An image forming apparatus comprising the developing device according to claim 4.

13. An image forming apparatus comprising the developing device according to claim 5.

14. An image forming apparatus comprising the developing device according to claim 6.

15. An image forming apparatus comprising the developing device according to claim 7.

16. An image forming apparatus comprising the developing device according to claim 8.

17. A developing device comprising:
first transport means that includes a helical rotational body and transports a developer by the rotational body being rotated;
second transport means that includes a helical rotational body and transports the developer in a direction opposite to a direction of the first transport means by the rotational body being rotated, the rotational body of the second transport means having a rotation shaft disposed above or below and in parallel to the rotational body of the first transport means;
developing means that develops an image with the developer supplied from the first transport means;
torque detecting means that detects a torque required for driving the first transport means and the second transport means;
first drive means that drives the first transport means and the second transport means at a rotational speed that is specified based on the torque detected by the torque detecting means; and
second drive means that differs from the first drive means and drives the developing means.
